(19) United States
(12) Patent Application Publication
(10) Pub. No.: US 2019/0187722 A1
(43) Pub. Date: Jun. 20, 2019

(54) METHOD AND APPARATUS FOR INTELLIGENT TERRAIN IDENTIFICATION, VEHICLE-MOUNTED TERMINAL AND VEHICLE

(71) Applicants: Neusoft Corporation, Shenyang (CN); Neusoft Reach Automotive Technology (Shanghai) Co. Ltd., Shanghai (CN)

(72) Inventors: Jun HU, Shenyang (CN); Huan TIAN, Shenyang (CN); Shuai CHENG, Shenyang (CN); Wei LIU, Shenyang (CN)

(21) Appl. No.: 15/950,200

(22) Filed: Apr. 11, 2018

(30) Foreign Application Priority Data
Dec. 14, 2017 (CN) 201711340588.5

(51) Int. Cl. G05D 1/02; G05D 1/00; G06K 9/00; G06K 9/20; G06K 9/34; G06K 9/66

(52) U.S. Cl. CPC G05D 1/0251; G05D 1/0088; G05D 1/0212; G05D 1/0238; G05D 2201/0213; G06K 9/2054; G06K 9/346; G06K 9/66; G06K 9/00791

(57) ABSTRACT

A method and an apparatus for intelligent terrain identification, a vehicle-mounted terminal, and a vehicle are provided. The method includes acquiring an image of a preset driving range in a front driving region of a vehicle; extracting a feature of a road surface from the image, and determining a type of the road surface based on the extracted feature of the road surface, to cause the vehicle to select a corresponding driving strategy according to the type of the road surface. With the method for intelligent terrain identification, the vehicle can identify the type of the current road surface intelligently, and switch the driving strategy of the vehicle automatically according to the type of the road surface, thereby greatly improving convenience of an adaptation function of the vehicle to a terrain, improving driving experience, and reducing probability of safety risks.

### CROSS REFERENCE TO RELATED APPLICATION

The application claims the priority to Chinese Patent Application No. 201711340588.5, titled “METHOD AND APPARATUS FOR INTELLIGENT TERRAIN IDENTIFICATION, VEHICLE-MOUNTED TERMINAL AND VEHICLE”, filed on Dec. 14, 2017 with the State Intellectual Property Office of the People's Republic of China, which is incorporated herein by reference in entirety.

### TECHNICAL FIELD

The present disclosure relates to the technical field of intelligent drive, and in particular to a method and an apparatus for intelligent terrain identification, a vehicle-mounted terminal, and a vehicle.

### BACKGROUND

In practical driving experience, driving strategies corresponding to different terrain conditions are provided for a vehicle when the vehicle is delivered from factory. In one aspect, it is for safety concerns. Under different terrain conditions, the vehicle has different fraction coefficients between wheels and ground, and has different braking distances, which may serve as inputs of autonomous emergency breaking (AEB), to improve driving safety. In another aspect, it is for comfort concerns, and comfortable, stable and fuel-efficient driving strategies are provided for users. That is, relevant parameters of the vehicle may be adjusted for different terrains such as highway, sand, snow, mud and grass, so that the different terrains correspond to different driving strategies, which not only provides good driving experience for the users but also reduces damages to the vehicle.

At present, selection of a driving strategy is mainly based on a manual manner. A terrain condition is observed by eyes of a driver, and a driving mode is manually switched via a function button according to the observed terrain condition, to switch to a driving mode according with a current terrain condition.

The conventional terrain identification technology is based on a manner in which the driver determines the terrain manually and then selects the corresponding driving strategy manually, which not only influences the driving experience but also results in problems such as various safety risks.

### SUMMARY

To address the above technical problems in the conventional technology, a method and an apparatus for intelligent terrain identification, a vehicle-mounted terminal, and a vehicle are provided according to the present disclosure, which can automatically identify a type of a road surface and automatically regulate a driving strategy according to a terrain of the road surface.

In view of the above, the following technical solutions are provided according embodiments of the present disclosure.

A method for intelligent terrain identification is provided according to an embodiment of the present disclosure, including:
acquiring an image of a preset driving range in a front driving region of a vehicle;
extracting a feature of a road surface from the image; and
determining a type of the road surface based on the extracted feature of the road surface, to cause the vehicle to select a corresponding driving strategy according to the type of the road surface.

In one embodiment, before extracting the feature of the road surface from the image, the method further includes:
performing pixel analysis on the image based on a deep neural network to segment the image to acquire a ground region; and
extracting the feature of the road surface from the image includes: extracting the feature of the road surface from the ground region based on the deep neural network.

In one embodiment, performing the pixel analysis on the image based on the deep neural network to segment the image to acquire the ground region includes:
performing the pixel analysis on the image based on the deep neural network, to acquire the ground region, a sky region, and a three-dimensional object of the image;
removing a three-dimensional object located in the ground region; and
performing image compensation on an empty part to acquire a complete ground region, where the empty part is formed in the ground region after the three-dimensional object located in the ground region is removed.

In one embodiment, performing the image compensation on the empty part, where the empty part is formed in the ground region after the three-dimensional object located in the ground region is removed, includes: performing the image compensation on the empty part based on an image feature of a region, where the region is in the ground region and is adjacent to the three-dimensional object located in the ground region.

In one embodiment, acquiring the image of the preset driving range in the front driving region of the vehicle includes: acquiring the image of the preset driving range in the front driving region of the vehicle via a camera installed in a front of the vehicle, where the preset driving range may be set by setting a parameter of the camera.

In one embodiment, determining the type of the road surface based on the extracted feature of the road surface includes: determining the type of the road surface based on the extracted feature of the road surface with a softmax function.

In one embodiment, extracting the feature of the road surface from the ground region based on the deep neural network includes: extracting the feature of the road surface from the ground region sequentially with at least one convolutional layer and at least one fully connected layer.

An apparatus for intelligent terrain identification is further provided according to an embodiment of the present disclosure, including:
an image acquisition device, configured to acquire an image of a preset driving range in a front driving region of a vehicle;
a feature extraction device, configured to extract a feature of a road surface from the image; and
a type determination device, configured to determine a type of the road surface based on the extracted feature of the road surface, to cause the vehicle to select a corresponding driving strategy according to the type of the road surface.

In one embodiment, the apparatus further includes a segmentation device, where
the segmentation device is configured to perform pixel analysis on the image based on a deep neural network to segment the image to acquire a ground region; and
the feature extraction device is configured to extract the feature of the road surface from the ground region based on the deep neural network.

In one embodiment, the segmentation device includes:
a segmentation subdevice, configured to perform the pixel analysis on the image based on the deep neural network, to acquire the ground region, a sky region, and a three-dimensional object of the image;
a removal subdevice, configured to remove a three-dimensional object located in the ground region; and
a compensation subdevice, configured to perform image compensation on an empty part to acquire a complete ground region, where the empty part is formed in the ground region after the three-dimensional object located in the ground region is removed.

In one embodiment, the compensation subdevice is configured to perform the image compensation on the empty part based on an image feature of a region, where the region is in the ground region and adjacent to the three-dimensional object located in the ground region.

A vehicle-mounted terminal applied to a vehicle is further provided according to an embodiment of the present disclosure, including a camera and a processor; where
the camera is configured to acquire an image of a preset driving range in a front driving region of the vehicle; and
the processor is configured to: extract a feature of a road surface from the image; determine a type of the road surface based on the extracted feature of the road surface; and send the type of the road surface to a vehicle control device of the vehicle, to cause the vehicle control device to control the vehicle to select a corresponding driving strategy according to the type of the road surface.

In one embodiment, the processor is configured to: perform pixel analysis on the image based on a deep neural network to segment the image to acquire a ground region; and extract the feature of the road surface from the ground region based on the deep neural network.

A vehicle is further provided according to an embodiment of the present disclosure, including the vehicle-mounted terminal and the vehicle control device, where the vehicle control device is configured to control the vehicle to select the corresponding driving strategy according to the type of the road surface.

In one embodiment, the image of the preset driving range in the front driving region of the vehicle is acquired. The feature of the road surface is extracted from the image. The type of the road surface is determined based on the extracted feature of the road surface, to cause the vehicle to select the corresponding driving strategy according to the type of the road surface.

In one embodiment, in the method according to the present disclosure, the image of the front driving region of the vehicle is automatically acquired, and the type of the road surface is determined based on the extracted feature by extracting the feature reflecting a terrain of the road surface. As a result, there is no need for a driver to observe the terrain by eyes and alter the driving strategy by selecting a function button manually. With the method, automatic identification can be intelligently performed on various terrains on which the vehicle currently drives, thereby helping the driver switch among different driving strategies quickly and automatically. In one aspect, adaptability of the vehicle to the terrain is greatly improved, and driving experience is improved. In another aspect, safety risks caused when the driver performs switching operations on the vehicle are prevented

### BRIEF DESCRIPTION OF THE DRAWINGS

The drawings described hereinafter merely illustrate some embodiments of the present disclosure.

FIG. 1 is a flow chart of a method for intelligent terrain identification according to a first embodiment of the present disclosure;

FIG. 2A is a flow chart of a specific implementation of S102 according to a second embodiment of the present disclosure;

FIG. 2B is another flow chart of a method for intelligent terrain identification according to a third embodiment of the present disclosure;

FIG. 3 is a schematic diagram of extracting a feature of a road surface according to the present disclosure;

FIG. 4 is a schematic diagram of classifying an extracted feature based on a softmax function according to the present disclosure;

FIGS. 5A to 5D are schematic diagrams of a scene in a practical application according to the present disclosure;

FIG. 6 is a structural diagram of an apparatus for intelligent terrain identification according to a fourth embodiment of the present disclosure;

FIG. 7 is a structural diagram of a vehicle-mounted terminal according to a fifth embodiment of the present disclosure; and

FIG. 8 is a schematic structural diagram of a vehicle according to a sixth embodiment of the present disclosure.

### DETAILED DESCRIPTION OF THE EMBODIMENTS

In embodiments of the present disclosure are described hereinafter in conjunction with the drawings of the embodiments of the present disclosure. Apparently, the embodiments described herein are only a few rather than all of the embodiments of the disclosure.

The inventor discovers in research that an identification technology for different terrains mainly depends on a driver. The driver observes a current terrain on which a vehicle drives, makes a determination, and then manually switches to a driving mode matching the current terrain. The conventional driving mode switching depends on the driver to make a determination based on a practical terrain feature, and then to select a corresponding driving mode manually.

In one aspect, it is difficult for the driver to switch the driving mode accurately in time. In another aspect, the driver needs to operate the vehicle in a process of switching, which distracts the driver and results in safety risks to some extent. Therefore, the conventional driving mode switching for different terrains not only impacts driving experience of the driver, but also distracts the driver, resulting in safety risks.

In view of the above, a method for intelligent terrain identification is provided according to an embodiment of the present disclosure. In one embodiment, an image of a preset driving range in a front driving region of a vehicle is automatically acquired, a feature of a road surface is extracted from the image by analysis, and a type of the road surface is determined based on the extracted feature of the road surface, so that the vehicle automatically switches to a matched driving mode according to the type of the road surface. It can be seen that, with the method according to the embodiment of the present disclosure, the vehicle can identify the type of the current road surface intelligently and switch a driving strategy of the vehicle automatically based on the type of the road surface, which greatly improves convenience of an adaptation function of the vehicle to the terrain, improves driving experience, and reduces probability of safety risks.

Additionally, in a case that there is another three-dimensional object, such as another vehicle or an obstacle, in the acquired image, the image can be segmented based on the method according to the present disclosure to obtain image information of a ground region, a three-dimensional object in the ground region is removed, and the image with an empty part is compensated to acquire an image of a complete ground region. In this way, stable and reliable image information is provided for extracting a feature of the ground region, thereby ensuring accurate determining of the type of the road surface.

### First Embodiment

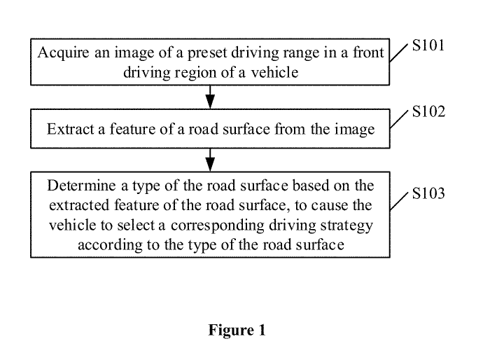

Reference is made to FIG. 1, which is a flow chart of a method for intelligent terrain identification according to the embodiment.

The method for intelligent terrain identification according to the embodiment includes steps S101 to S103.

In S101, an image of a preset driving range in a front driving region of a vehicle is acquired.

It can be understood that there is no need to set the preset driving range too large. In practice, a predetermined width and a predetermined distance in front of the vehicle in a driving direction are set. For example, an image within a region in front of the vehicle is acquired, where the region has a width of 10 meters from left to right and a length of 20 meters in the driving direction.

In the embodiment, different image acquisition ranges may be set for different types of the vehicle with the preset driving range, so as to adapt to structures of the different vehicles. In this way, a relatively ideal image can be acquired, to perform subsequent image processing and acquire accurate data.

For example, the types of the vehicle include an off-road vehicle, a car, a truck, a van, and the like.

The off-road vehicle has a large overall structure, and the car has a relatively small overall structure. Therefore, when setting the preset driving ranges in the front driving regions corresponding to the above two different types of vehicles, adjustment needs to be adaptively made based on respective features to set reasonable preset driving ranges.

The image may be a binary image, a gray-scale image, or a color image, which is not limited in the embodiment.

A specific implementation of acquiring the image of the preset driving range in the front driving region of the vehicle may be achieved by installing a camera, a dashboard camera, or the like, in the front of the vehicle.

In S102, a feature of a road surface is extracted from the image.

In the embodiment, the feature of the road surface is for indicating a feature of a terrain on which the vehicle currently drives. Different terrains correspond to different features of road surfaces.

The feature of the road surface may include a color, a shape, or a texture of the road surface.

For example, different terrains such as highway, sand, snow, mud and grass correspond to different colors, shapes and textures of road surfaces.

Therefore, the terrain on which the vehicle currently drives may be identified by extracting the feature of the road surface. In a practical application, one or more types of the above features of the road surface may be extracted, which is not limited herein. In one embodiment, the number of the extracted feature of the road surface may be more than one, so as to identify the current terrain accurately.

In S103, a type of the road surface is determined based on the extracted feature of the road surface, to cause the vehicle to select a corresponding driving strategy according to the type of the road surface.

From the description of S102, it can be seen that the terrain may include multiple types such as highway, sand, snow, mud, and grass, and the different terrains present different features of road surfaces. The type of the road surface on which the vehicle currently drives is determined based on the extracted feature of the road surface, so that the vehicle can select the corresponding driving strategy automatically according to the type of the road surface.

In the embodiment, features of different types of road surfaces may be extracted in advance, and a feature sample set corresponding to each type of the road surface is acquired by training. When determining the type of the road surface on which the vehicle currently drives, the extracted feature may be matched with a feature in the feature sample set to obtain a match result, and the type of the road surface is determined.

It can be appreciated that, in a practical application, other determination manners may be used, which is not limited herein by the embodiment.

Classification of the driving strategy corresponds to classification of the terrain. For example, a driving strategy matching the highway is selected in a case that the current terrain is determined to be the highway; and a driving strategy matching the snow is selected in a case that the current terrain is determined to be the snow. Different driving strategies are acquired by adjusting multiple systems such as a steering system, an electronic stability control system, and a chassis suspension system, to adapt to different terrains, prevent damages to the vehicle, and save fuel. Also, driving safety is ensured to prevent an accident. For example, the vehicle is slowed down in a case of driving on the snow, so as to prevent a slip or a side slip.

It can be understood that the specific driving strategy may be selected according to the terrain and a type of the vehicle, which is not described in detail in the embodiment.

With the method according to the present disclosure, the image of the front driving region of the vehicle is automatically acquired, the type of the road surface is determined based on the extracted feature by extracting the feature reflecting the terrain of the road surface. There is no need for a driver to observe the terrain by eyes and alter the driving strategy by selecting a function button manually. In this way, the vehicle selects the corresponding driving strategy automatically according to the type of the road surface. It can be seen that, the terrain on which the vehicle currently drives can be automatically and intelligently identified by extracting and determining the feature of the road surface. In one aspect, adaptability of the vehicle to the terrain is greatly improved, and driving experience is improved. In another aspect, safety risks caused when the driver performs switching operations on the vehicle are prevented.

The method for intelligent terrain identification is described in the above according to the first embodiment, and hereinafter a specific implementation of S102 in the first embodiment is introduced in detail in conjunction with a second embodiment.

### Second Embodiment

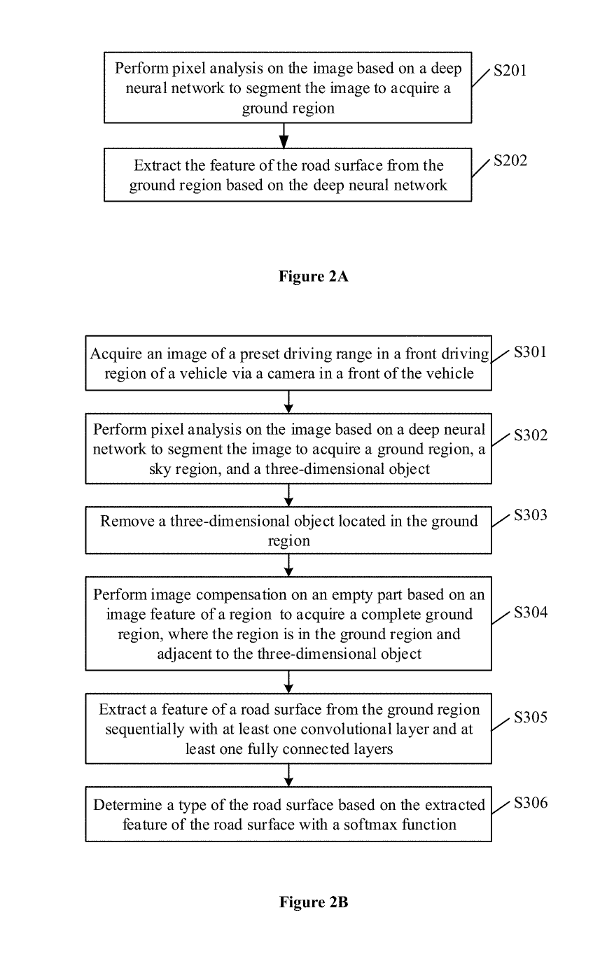

Reference is made to FIG. 2A, which is a flow chart of a specific implementation of S102 according to the embodiment.

The specific implementation includes following steps.

S102 in the first embodiment includes steps S201 and S202.

In S201, pixel analysis is performed on the image based on a deep neural network, to segment the image to acquire a ground region.

In the embodiment, an image acquisition manner is provided, which includes acquire the image of the preset driving range in the front driving region of the vehicle via a camera installed in a front of the vehicle, where the preset driving range is set by setting a parameter of the camera.

The parameter of the camera may include an intrinsic parameter and an extrinsic parameter. The intrinsic parameter includes focal lengths fx and fy, coordinates (x0, y0) of a principle point (with respect to an imaging plane), a coordinate axis tilting parameter s, and so on. The extrinsic parameter includes a rotation matrix, a translation matrix, and so on. Different parameters of camera are set for different vehicles, so that the camera can shot the image of a reasonable preset driving range.

In a practical application, the parameter of the camera may be set in advance when the vehicle is delivered from factory, and may be set by a driver based on practical driving experience. In the embodiment, a manner of setting the parameter of the camera is not limited, and a specific value of the parameter may be set based on a practical driving situation.

In a specific implementation, the image of the preset driving range in the front driving region of the vehicle may be shot via a dashboard camera. It should be noted that, in the embodiment, the image of the front driving region of the vehicle may be acquired in various manners, which is not limited herein.

It can be understood that the image may be shot with a preset time interval, and may be an image extracted from a video recorded in a real-time manner.

In a practical application, there is inevitably another vehicle and/or an obstacle such as a pedestrian, in the front driving region of the vehicle. A processing manner is provided according to the embodiment, to ensure accuracy and uniqueness of image information collected in subsequent steps and acquire a stable and reliable feature of the road surface. The processing manner includes:

performing pixel analysis on the image based on the deep neural network, to acquire the ground region, a sky region, and a three-dimensional object of the image;

removing a three-dimensional object located in the ground region; and

performing image compensation on an empty part to acquire a complete ground region, where the empty part is formed in the ground region after the three-dimensional object located in the ground region is removed.

In a practical application, in order to extract a feature of the ground region, image segmentation may be performed to acquire the ground region, the sky region and the three-dimensional object in the image. The image segmentation is to classify different objects in the image, and borders of the objects are determined via analysis on pixels of the objects to achieve separation of the different objects.

In a specific implementation, the shot image is inputted into the deep neural network, and the sky region, the ground region and a region of the three-dimensional object are separated by classifying each pixel in the image, so as to extract the feature of the ground region accurately.

In a practical application, the image shot by the camera generally includes a ground, a sky and the three-dimensional object. In extracting the feature of the road surface, the sky region of the image and the three-dimensional object located in the ground region of the image are removed, to prevent the sky region and the three-dimensional object from influencing accuracy of extracting the feature of the road surface. Thereby, it is ensured that a feature presented by the image is the feature of the ground region, which provides a reliable basis for extracting the feature of the road surface.

After the three-dimensional object is removed, an image of the ground region with the empty part needs to be compensated, to acquire a complete image. In the embodiment, an implementation to compensate the empty part is provided, which includes performing the image compensation on the empty part based on an image feature of a region, where the region is in the ground region and adjacent to the three-dimensional object located in the ground region.

For example, the region adjacent to the three-dimensional object may include a sky and a ground. Since the feature of the road surface of the ground region is finally to be extracted, the image feature of the region which is adjacent to the three-dimensional object and is in the ground region, needs to be used to compensate the empty part, instead of using a region which is adjacent to the three-dimensional object and is in another region.

In a specific implementation, a generative model in the deep neural network may be applied to sampling a feature of the ground region adjacent to the three-dimensional object, i.e., sampling a ground feature of the ground region where the three-dimensional object is located, and the empty part is compensated based on a feature sample set of the ground region obtaining from sampling, thereby generating an image of the ground region without interference, so as to extract the feature of the road surface through step S202.

In S202, the feature of the road surface is extracted from the ground region based on the deep neural network.

The image of the ground region without interference is acquired by further processing the acquired image through step S201. The feature of the road surface is extracted from the ground region based on the deep neural network, and there may be multiple specific implementations of extracting. An implementation is provided according to the embodiment, which includes extracting the feature of the road surface from the ground region sequentially with at least one convolutional layer and at least one fully connected layer.

The convolutional layer is for extracting the feature of the road surface from the ground region inputted into the deep neural network structure. The fully connected layer is for converting a multi-dimensional vector outputted by the convolutional layer into a one-dimensional feature vector, so that calculation processing is subsequently performed with the one-dimensional feature vector.

Theoretically, accuracy of an extracted effective feature vector increases as the number of the convolutional layer and the fully connected layer in the deep neural network structure increases. However, the increased number of the layers results in increased consumption of resources of a CPU, which influences a performance of the CPU in processing other objects. Therefore, in a specific implementation, the number of the convolutional layer and the number of the fully connected layer may be selected based on practical requirements, and there is at least one convolutional layer and at least one fully connected layer.

In comprehensive consideration of calculation accuracy and CPU performance, in the embodiment, the deep neural network structure for extracting the feature of the road surface of the ground region is a convolutional neural network formed by three convolutional layers and two fully connected layers. However, the three convolutional layers and the two fully connected layers are only taken as an example for illustration, and are not to limit the number of the convolutional layer and the number of the fully connected layer.

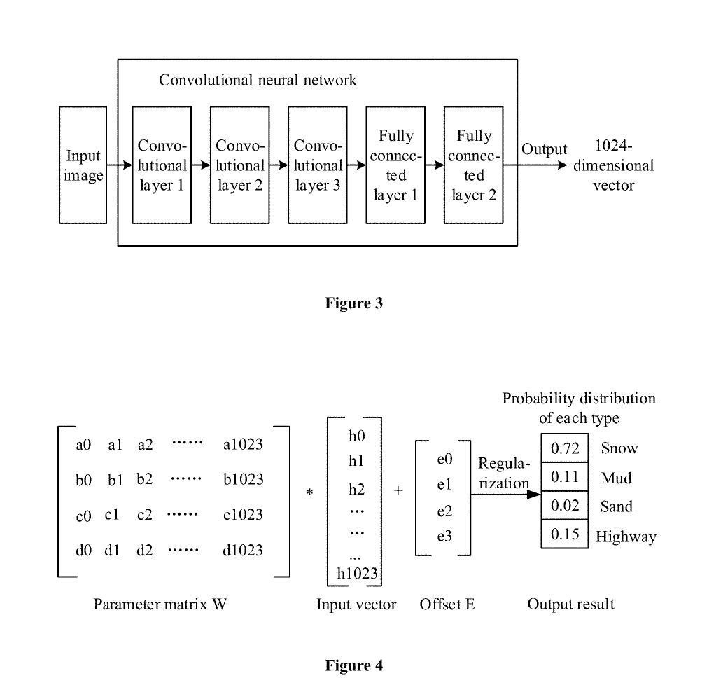

For a specific implementation of the deep neural network structure adopted in the embodiment, reference can be made to FIG. 3.

First, the image of the ground region is inputted, and a specific process of extracting the feature of the road surface from the complete ground region based on the deep neural network structure is as follows:

convolutional layer 1: 3*3 kernels, 64 maps, including one pooling layer;

convolutional layer 2: 3*3 kernels, 128 maps, including one pooling layer;

convolutional layer 3: 3*3 kernels, 128 maps, including one pooling layer;

fully connected layer 1: 2048 dimensions; and

fully connected layer 2: 1024 dimensions.

After the above processing, the deep neural network outputs a 1024-dimensional feature vector, so that the type of the road surface can be determined based on the outputted 1024-dimensional feature vector in the subsequent.

In the embodiment, determining the type of the road surface based on the extracted feature of the road surface is provided, which includes determining the type of the road surface based on the extracted feature of the road surface with a softmax function.

It should be noted that, the softmax function maps a K-dimensional vector A to a K′-dimensional vector A′, and is a probability function in essence. In the embodiment, the softmax function is for indicating a probability distribution of a terrain classification result, and reference can be made to a process shown in FIG. 4 for a specific calculation.

The 1024-dimensional feature vector outputted by the deep neural network is inputted into the softmax function. The inputted vector is multiplied by a parameter matrix W, then an offset vector E is added to a result obtain after the multiplying, and finally a result obtained after the adding is regularized to obtain a probability of each type as shown in FIG. 4.

The parameter matrix W is an a*b matrix and the offset vector E is an a*1 vector, which are acquired by training based on a large number of feature sample sets of road surface in advance and may be used to determine the type of the road surface. a is the number of rows and is the same as the number of the types of the road surface. b is the number of columns and is the same as a dimensionality of the feature vector outputted by the deep neural network.

It is assumed that the types of the road surface include four types: snow, mud, sand and highway. A vector with dimensions of 4*1 is acquired after calculating based on the above softmax function, and represents a probability distribution of the above four types of the road surface. The type of the road surface with a maximum probability is the type of the road surface determined based on the feature of the road surface by the softmax function. In the embodiment, the terrain on which the vehicle currently drives has a probability of 0.72 of being the snow, a probability of 0.11 of being the mud, a probability of 0.02 of being the sand, and a probability of 0.15 of being the highway. From the above distribution of probability values, it can be determined that the type of the current road surface is the snow, and thereby the vehicle selects the driving strategy corresponding to the snow.

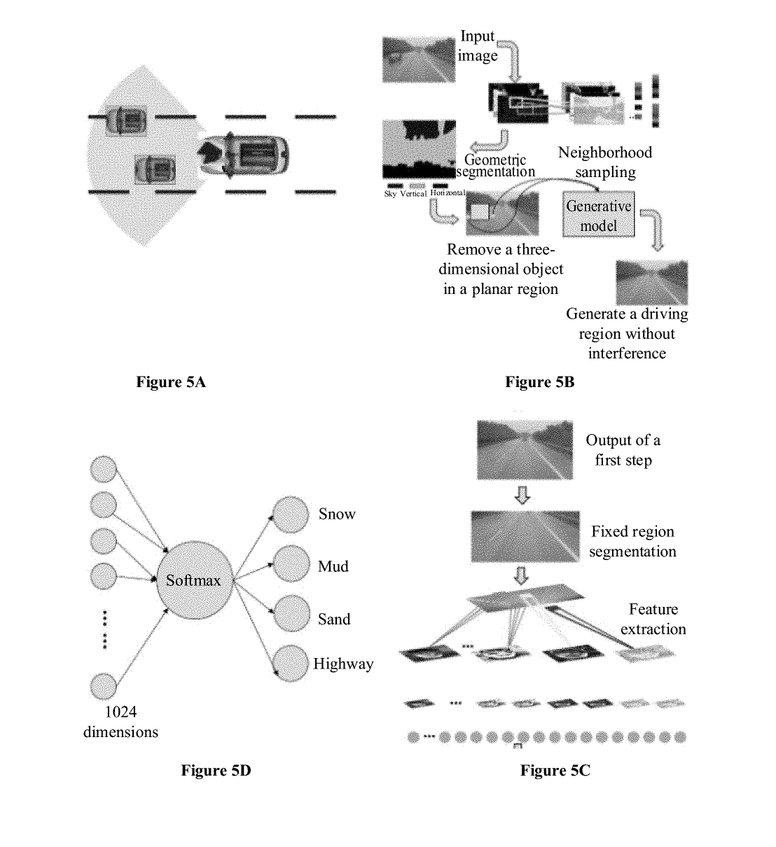

For better understanding of the above features of the present disclosure, the method according to the above embodiments of the present disclosure is described in detail hereinafter in conjunction with FIGS. 5A to 5D.

The image of the front driving range of the vehicle is acquired by setting the parameter of the camera installed in the front of the vehicle. As an example, an image in a fan-shaped region is shown in FIG. 5A.

The acquired image is inputted into the deep neural network, the inputted image is segmented, and the sky, the ground and the three-dimensional object in the image are identified. In one embodiment, objects may be identified based on a texture, a color or an intensity in the image.

The three-dimensional object, i.e., a front vehicle and a pedestrian shot by the camera, in the ground region is removed. The empty part can be compensated when the image with the three-dimensional object removed passes the generative model, to generate the image of the ground region without interference, as shown in FIG. 5B. Before the image is inputted into a convolutional neural network, the image may be segmented again, and the segmented image is inputted into the convolutional neural network. The 1024-dimensional feature vector is acquired by processing through the convolutional layers and the fully connected layers, as shown in FIG. 5C.

The 1024-dimensional vector is inputted into the softmax function, and the probability distribution of each type of the road surface is acquired, as shown in FIG. 5D. The type of the road surface on which the vehicle drives is determined according to the probability distribution, so that the vehicle selects the corresponding driving strategy according to the type of the road surface.

With the method according to the embodiment, when the shot image includes the sky and the three-dimensional object, the image may be segmented via the deep neural network to acquire the sky region, the ground region and the three-dimensional object, so as to prevent the sky and the three-dimensional object from influencing extraction of the feature of the road surface. The three-dimensional object in the ground region is removed; and the empty part, which is formed by removing the three-dimensional object, in the ground region is compensated. In this way, the complete and stable image of the ground region is acquired, providing reliable image information for the subsequent extraction of the feature of the road surface, and improving accuracy of determination of the type of the road surface.

### Third Embodiment

For better understanding the above features and advantages of the present disclosure, the present disclosure is further illustrated in detail hereinafter in conjunction with FIG. 2B.

Reference is made to FIG. 2B, which is another flow chart of a method for intelligent terrain identification according to the embodiment. The method includes steps S301 to S306.

In S301, an image of a preset driving range in a front driving region of a vehicle is acquired via a camera installed in a front of the vehicle.

The preset driving range may be set by setting a parameter of the camera. Different parameters may be set for different vehicles, so that the camera can shot a clear and accurate image.

In S302, pixel analysis is performed on the image based on a deep neural network to segment the image to acquire a ground region, a sky region, and a three-dimensional object.

In S303, a three-dimensional object located in the ground region is removed.

In a practical application, in order to prevent the sky region and the three-dimensional object in the image from influencing accuracy of extracting a feature of the road surface, the sky region of the image and the three-dimensional object in the ground region of the image needs to be removed, to provide a reliable basis for extracting the feature of the road surface.

In S304, image compensation is performed on an empty part, which is formed in the ground region after the three-dimensional object located in the ground region is removed, based on an image feature of a region adjacent to the three-dimensional object and in the ground region, to acquire a complete ground region.

A generative model in the deep neural network may be applied to sampling a feature of the ground region adjacent to the three-dimensional object located in the ground region, and the empty part is compensate based on a collected feature sample set of the ground region, thereby acquiring a complete image of the ground region.

In S305, the feature of the road surface is extracted from the ground region sequentially with three convolutional layers and two fully connected layers.

In the embodiment, for a specific implementation of the step S305, reference can be made to the specific implementation in the second embodiment, which is not described in detail herein.

In S306, a type of the road surface is determined based on the extracted feature of the road surface with a softmax function.

For a calculation principle and an implementation of the softmax function, reference can be made to the specific implementation in the second embodiment, which is not described in detail herein.

With the method according to the embodiment, the image of the front driving region of the vehicle is automatically acquired via the camera, the three-dimensional object in the image is removed with an image segmentation method, the empty part formed in the ground region by removing the three-dimensional object is compensated to acquire the complete and stable image of the ground region, then a feature reflecting a terrain of the road surface is extracted from the image, and the type of the road surface is determined based on the extracted feature. It can be seen that, with the method according to the embodiment, the terrain on which the vehicle currently drives can be identified automatically and intelligently. In one aspect, adaptability of the vehicle to the terrain is greatly improved. In another aspect, safety risks caused when a driver performs switching operations on the vehicle are prevented.

Based on the method for intelligent terrain identification according to the first embodiment to the third embodiment mentioned above, an apparatus for intelligent terrain identification is further provided according to an embodiment of the present disclosure. Hereinafter the apparatus for intelligent terrain identification is introduced according to a fourth embodiment in conjunction with drawings.

### Fourth Embodiment

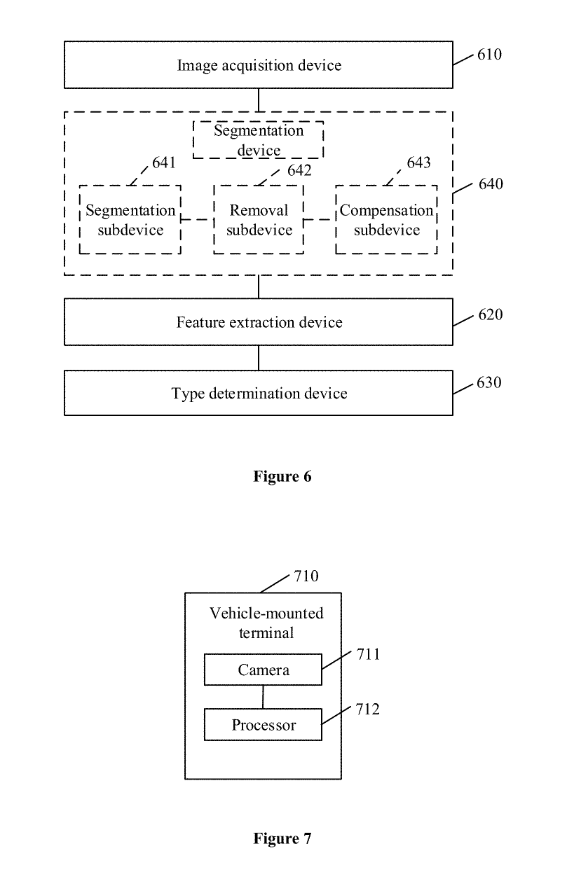

Reference is made to FIG. 6, which illustrates a structural diagram of an apparatus for intelligent terrain identification according to the embodiment.

The apparatus includes an image acquisition device 610, a feature extraction device 620, and a type determination device 630.

The image acquisition device 610 is configured to acquire an image of a preset driving range in a front driving region of a vehicle.

The feature extraction device 620 is configured to extract a feature of a road surface from the image.

The type determination device 630 is configured to determine a type of the road surface based on the extracted feature of the road surface, to cause the vehicle to select a corresponding driving strategy according to the type of the road surface.

In one embodiment, the apparatus may further include a segmentation device 640 configured to perform pixel analysis on the image based on a deep neural network to segment the image to acquire a ground region, and the feature extraction device 620 is configured to extract the feature of the road surface from the ground region based on the deep neural network.

In one embodiment, the segmentation device 640 includes a segmentation subdevice 641, a removal subdevice 642, and a compensation subdevice 643.

The segmentation subdevice 641 is configured to perform pixel analysis on the image based on the deep neural network, to acquire the ground region, a sky region, and a three-dimensional object of the image.

The removal subdevice 642 is configured to remove a three-dimensional object located in the ground region.

The compensation subdevice 643 is configured to perform image compensation on an empty part to acquire a complete ground region, where the empty part is formed in the ground region after the three-dimensional object located in the ground region is removed. In one embodiment, the compensation subdevice 643 is configured to perform the image compensation on the empty part based on an image feature of a region, where the region is in the ground region and adjacent to the three-dimensional object located in the ground region.

The apparatus according to the embodiment corresponds to the method according to the first embodiment to the third embodiment. Therefore, reference can be made to the implementations of the method embodiments for a specific implementation of a function of each device in the embodiment, which is not described in detail herein.

With the apparatus for intelligent terrain identification according to the embodiment, the image of the preset driving range in the front driving region of the vehicle can be intelligently collected, and the type of the road surface on which the vehicle currently drives is automatically identified, to switch the driving strategy of the vehicle. In one aspect, adaptability of the vehicle to the terrain is greatly improved, and driving experience is improved. In another aspect, safety risks caused when a driver performs switching operations on the vehicle are prevented. Moreover, the three-dimensional object in the ground region is removed by segmentation processing on the image, and the formed empty part is compensated. Thereby, a stable and reliable feature of the road surface can be extracted, and accuracy of a determination result of the type of the road surface is ensured.

Based on the method and the apparatus for intelligent terrain identification according to the above embodiments, a vehicle-mounted terminal is further provided according to the present disclosure. Detailed descriptions are provided hereinafter in conjunction with drawings.

The vehicle-mounted terminal may be applied to vehicles of various types, such as a car, an off-road vehicle, a truck, and a van, so as to implement a function of intelligent terrain identification according to the present disclosure.

### Fifth Embodiment

Reference is made to FIG. 7, which shows a schematic structural diagram of a vehicle-mounted terminal according to an embodiment of the present disclosure. The vehicle-mounted terminal 710 includes a camera 711 and a processor 712.

The camera 711 is configured to acquire an image of a preset driving range in a front driving region of a vehicle, where the preset driving range is set by setting a parameter of the camera.

The processor 712 is configured to: extract a feature of a road surface from the image; determine a type of the road surface based on the extracted feature of the road surface; and send the type of the road surface to a vehicle control device of the vehicle, to cause the vehicle control device to control the vehicle to select a corresponding driving strategy according to the type of the road surface.

In one embodiment, the processor 712 is configured to: perform pixel analysis on the image based on a deep neural network to segment the image to acquire a ground region; and extract the feature of the road surface from the ground region based on the deep neural network.

It can be appreciated that the vehicle-mounted terminal may serve as a separate product and apply to vehicles of various types.

Based on the method and the apparatus for intelligent terrain identification, and the vehicle-mounted terminal according to the above embodiments, a vehicle is further provided according to the present disclosure. Detailed descriptions are provided hereinafter in conjunction with drawings.

The vehicle may be of various types, such as a car, an off-road vehicle, a truck, and a van. And the vehicle may be vehicles with various power sources, such as a fuel vehicle and an electric vehicle.

### Sixth Embodiment

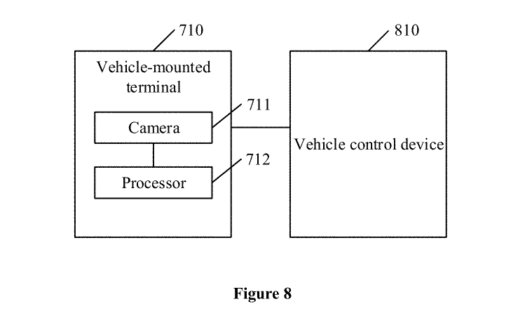

Reference is made to FIG. 8, which is a schematic structural diagram of a vehicle according to an embodiment of the present disclosure. The vehicle includes the vehicle-mounted terminal 710 according to the fifth embodiment and a vehicle control device 810.

The vehicle-mounted terminal 710 is configured to acquire an image of a preset driving range in a front driving region of the vehicle; extract a feature of a road surface from the image; determine a type of the road surface based on the extracted feature of the road surface; and send the type of the road surface to the vehicle control device.

The vehicle control device 810 is configured to control the vehicle to select a corresponding driving strategy according to the type of the road surface.

In one embodiment, the vehicle-mounted 710 includes a camera 711 and a processor 712.

The cameral 711 is configured to acquire the image of the preset driving range in the front driving region of the vehicle, where the preset driving range is set by setting a parameter of the camera.

The processor 712 is configured to: perform pixel analysis on the image based on a deep neural network to segment the image to acquire a ground region; and extract the feature of the road surface from the ground region based on the deep neural network.

With the vehicle according to the embodiment, the image of the preset driving range in the front driving region of the vehicle is shot via the camera, the pixel analysis is performed on the shot image based on the deep neural network via the processor to segment the image to acquire the ground region, the feature of the road surface of the ground region is extracted based on the deep neural network, the type of the road surface on which the vehicle currently drives is determined based on the feature of the road surface, and a determination result is fed back to the vehicle control device to cause the vehicle control device to select the driving strategy corresponding to the type of the road surface according to the determination result. In one aspect, adaptability of the vehicle to a terrain is greatly improved, and driving experience is improved. In another aspect, safety risks caused when a driver performs switching operations on the vehicle are prevented.

1. A method for intelligent terrain identification, comprising:
acquiring an image of a preset driving range in a front driving region of a vehicle;
extracting a feature of a road surface from the image; and
determining a type of the road surface based on the extracted feature of the road surface, to cause the vehicle to select a corresponding driving strategy according to the type of the road surface.

2. The method for intelligent terrain identification according to claim 1, wherein before extracting the feature of the road surface from the image, the method further comprises:
performing pixel analysis on the image based on a deep neural network to segment the image to acquire a ground region; and
wherein extracting the feature of the road surface from the image comprises:
extracting the feature of the road surface from the ground region based on the deep neural network.

3. The method for intelligent terrain identification according to claim 2, wherein performing the pixel analysis on the image based on the deep neural network to segment the image to acquire the ground region comprises:
performing the pixel analysis on the image based on the deep neural network, to acquire the ground region, a sky region, and a three-dimensional object of the image;
removing a three-dimensional object located in the ground region; and
performing image compensation on an empty part to acquire a complete ground region, wherein the empty part is formed in the ground region after the three-dimensional object located in the ground region is removed.

4. The method for intelligent terrain identification according to claim 3, wherein, performing the image compensation on the empty part, wherein the empty part is formed in the ground region after the three-dimensional object located in the ground region is removed, comprises:
performing the image compensation on the empty part based on an image feature of a region, wherein the region is in the ground region and adjacent to the three-dimensional object located in the ground region.

5. The method for intelligent terrain identification according to claim 1, wherein determining the type of the road surface based on the extracted feature of the road surface comprises:
determining the type of the road surface based on the extracted feature of the road surface with a softmax function.

6. The method for intelligent terrain identification according to claim 2, wherein extracting the feature of the road surface from the ground region based on the deep neural network comprises:
extracting the feature of the road surface from the ground region sequentially with at least one convolutional layer and at least one fully connected layer.

7. The method for intelligent terrain identification according to claim 1, wherein acquiring the image of the preset driving range in the front driving region of the vehicle comprises:
acquiring the image of the preset driving range in the front driving region of the vehicle via a camera installed in a front of the vehicle, wherein the preset driving range is set by setting a parameter of the camera.

8. An apparatus for intelligent terrain identification, comprising:
an image acquisition device, configured to acquire an image of a preset driving range in a front driving region of a vehicle;
a feature extraction device, configured to extract a feature of a road surface from the image; and
a type determination device, configured to determine a type of the road surface based on the extracted feature of the road surface, to cause the vehicle to select a corresponding driving strategy according to the type of the road surface.

9. The apparatus for intelligent terrain identification according to claim 8, further comprising a segmentation device;
wherein the segmentation device is configured to perform pixel analysis on the image based on a deep neural network to segment the image to acquire a ground region; and
wherein the feature extraction device is configured to extract the feature of the road surface from the ground region based on the deep neural network.

10. The apparatus for intelligent terrain identification according to claim 9, wherein the segmentation device comprises:
a segmentation subdevice, configured to perform the pixel analysis on the image based on the deep neural network, to acquire the ground region, a sky region, and a three-dimensional object of the image;
a removal subdevice, configured to remove a three-dimensional object located in the ground region; and
a compensation subdevice, configured to perform image compensation on an empty part to acquire a complete ground region, wherein the empty part is formed in the ground region after the three-dimensional object located in the ground region is removed.

11. The apparatus for intelligent terrain identification according to claim 10, wherein the compensation subdevice is configured to perform the image compensation on the empty part based on an image feature of a region, wherein the region is in the ground region and adjacent to the three-dimensional object located in the ground region.

12. A vehicle-mounted terminal applied to a vehicle, comprising:
a camera and a processor;
wherein the camera is configured to acquire an image of a preset driving range in a front driving region of the vehicle; and
wherein the processor is configured to: extract a feature of a road surface from the image; determine a type of the road surface based on the extracted feature of the road surface; and send the type of the road surface to a vehicle control device of the vehicle, to cause the vehicle control device to control the vehicle to select a corresponding driving strategy according to the type of the road surface.

13. The vehicle-mounted terminal according to claim 12, wherein the processor is configured to perform pixel analysis on the image based on a deep neural network to segment the image to acquire a ground region; and extract the feature of the road surface from the ground region based on the deep neural network.

14. A vehicle, comprising:
a vehicle-mounted terminal applied to a vehicle, comprising:
a camera and a processor;
wherein the camera is configured to acquire an image of a preset driving range in a front driving region of the vehicle; and
wherein the processor is configured to: extract a feature of a road surface from the image; determine a type of the road surface based on the extracted feature of the road surface; and send the type of the road surface to a vehicle control device of the vehicle, to cause the vehicle control device to control the vehicle to select a corresponding driving strategy according to the type of the road surface; and
a vehicle control device,
wherein the vehicle control device is configured to control the vehicle to select the corresponding driving strategy according to the type of the road surface.

15. The method for intelligent terrain identification according to claim 2, wherein acquiring the image of the preset driving range in the front driving region of the vehicle comprises:
acquiring the image of the preset driving range in the front driving region of the vehicle via a camera installed in a front of the vehicle, wherein the preset driving range is set by setting a parameter of the camera.

16. The method for intelligent terrain identification according to claim 3, wherein acquiring the image of the preset driving range in the front driving region of the vehicle comprises:
acquiring the image of the preset driving range in the front driving region of the vehicle via a camera installed in a front of the vehicle, wherein the preset driving range is set by setting a parameter of the camera.

17. The method for intelligent terrain identification according to claim 4, wherein acquiring the image of the preset driving range in the front driving region of the vehicle comprises:
acquiring the image of the preset driving range in the front driving region of the vehicle via a camera installed in a front of the vehicle, wherein the preset driving range is set by setting a parameter of the camera.

18. A vehicle, comprising:
a vehicle-mounted terminal applied to a vehicle, comprising:
a camera and a processor;
wherein the camera is configured to acquire an image of a preset driving range in a front driving region of the vehicle; and
wherein the processor is configured to: extract a feature of a road surface from the image; determine a type of the road surface based on the extracted feature of the road surface; and send the type of the road surface to a vehicle control device of the vehicle, to cause the vehicle control device to control the vehicle to select a corresponding driving strategy according to the type of the road surface, and
wherein the processor is configured to perform pixel analysis on the image based on a deep neural network to segment the image to acquire a ground region; and extract the feature of the road surface from the ground region based on the deep neural network; and
a vehicle control device,
wherein the vehicle control device is configured to control the vehicle to select the corresponding driving strategy according to the type of the road surface.
